(19) United States
(12) Patent Application Publication
(10) Pub. No.: US 2015/0056951 A1
(43) Pub. Date: Feb. 26, 2015

(54) VEHICLE TELEMATICS UNIT AND METHOD OF OPERATING THE SAME

(71) Applicant: GM GLOBAL TECHNOLOGY OPERATIONS LLC, Detroit, MI (US)

(72) Inventors: GAURAV TALWAR, FARMINGTON HILLS, MI (US); RON M. HECHT, RAANANA (IL); XUFANG ZHAO, WINDSOR (CA)

(73) Assignee: GM GLOBAL TECHNOLOGY OPERATIONS LLC, Detroit, MI (US)

(21) Appl. No.: 13/972,205

(22) Filed: Aug. 21, 2013

(51) Int. Cl. H04W 12/06; H04W 4/12

(52) U.S. Cl. CPC H04W 12/06; H04W 4/12
USPC 455/411; 455/26.1

(57) ABSTRACT

A vehicle telematics unit and method of operating the same is provided. In one embodiment, a method includes storing an application access code provided from a telematics service user, initiating a call from a vehicle to the application, and receiving a request for the access code from the application during the call. Furthermore, the method includes determining that the application has requested the access code using a speech recognition function at the vehicle and sending the stored access code to the application based on the determination of the speech recognition function.

### TECHNICAL FIELD

The technical field generally relates to vehicles, and more particularly relates to a method of operating a vehicle telematics unit.

### BACKGROUND

Vehicle manufacturers outfit their vehicles with an increasing number of wireless communications capabilities. Telematics units installed in modern vehicles are configured to wirelessly communicate both voice and data communications between the vehicle and a variety of recipients, such as a central facility or an outside caller. For instance, vehicle telematics units may both place and receive telephone calls at the vehicle. These calls may be initiated using verbal commands provided by a vehicle occupant or through physically-actuated inputs carried by the vehicle and manipulated by the vehicle occupant.

Access to and use of various features offered by the telematics unit may be conditioned on providing user-identifying information, such as a user-specific access code or a particular passcode. For the vehicle occupant, providing this information may be challenging. For example, the user may be required to enter a passcode using a physical keypad, while simultaneously attempting to operate the vehicle.

Accordingly, it is desirable to provide an improved vehicle telematics unit and method of operating the same. In addition, it is desirable to provide methods for use thereof that allow the user easy, yet secure, access to the systems and features of the telematics unit. Furthermore, other desirable features and characteristics of the present invention will become apparent from the subsequent detailed description and the appended claims, taken in conjunction with the accompanying drawings and the foregoing technical field and background.

### SUMMARY

A system is provided in connection with a vehicle telematics unit. In one embodiment, the system includes an access code database configured to store an application access code provided from a telematics service user, a telematics unit configured to initiate a call from a vehicle to the application, and an interaction manager configured to receiving a request for the access code from the application during the call. Furthermore, the system includes a speech recognition module configured to determine that the application has requested the access code and an electronic communication system configured to send the stored access code to the application based on the determination of the speech recognition function.

A method is provided for operating a vehicle telematics unit. In one embodiment, the method includes storing an application access code provided from a telematics service user, initiating a call from a vehicle to the application, and receiving a request for the access code from the application during the call. Furthermore, the method includes determining that the application has requested the access code using a speech recognition function at the vehicle and sending the stored access code to the application based on the determination of the speech recognition function.

### DESCRIPTION OF THE DRAWINGS

The exemplary embodiments will hereinafter be described in conjunction with the following drawing figures, wherein like numerals denote like elements, and wherein:

FIG. 1 is a block diagram of a communications system that is capable of utilizing the method disclosed herein in accordance with an exemplary embodiment;

FIG. 2 is a block diagram of an exemplary architecture for an ASR system in accordance with an exemplary embodiment;

FIG. 3 is a block diagram of an exemplary architecture for a password management system provided in connection with the ASR system and the communications system in accordance with an exemplary embodiment;

FIGS. 4-7 illustrate methods for operating the password management system in accordance with an exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

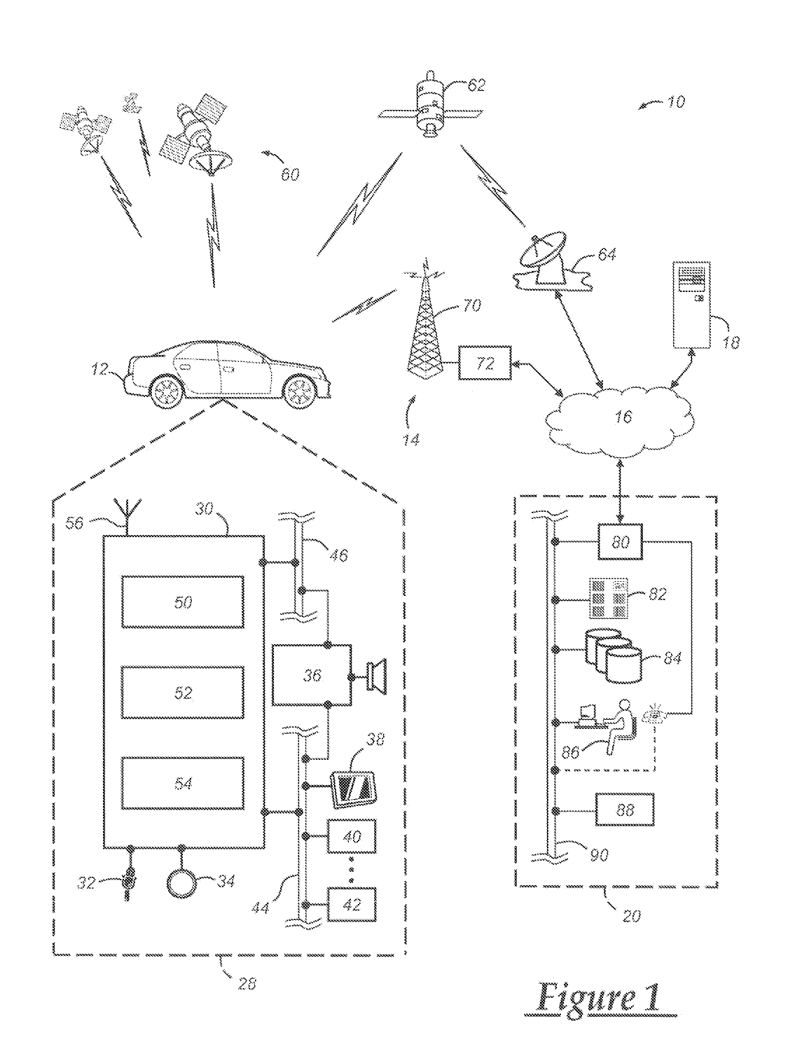

With reference to FIG. 1, there is shown an exemplary operating environment that includes a mobile vehicle communications system 10 and that may be used to implement the method disclosed herein. Communications system 10 generally includes a vehicle 12, one or more wireless carrier systems 14, a land communications network 16, a computer 18, and a call center 20. It should be understood that the disclosed method may be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., may also be used. Some of the vehicle electronics 28 are shown generally in FIG. 1 and include a telematics unit 30, a microphone 32, one or more pushbuttons or other control inputs 34, an audio system 36, a visual display 38, and a GPS module 40 as well as a number of vehicle system modules (VSMs) 42. Some of these devices may be connected directly to the telematics unit such as, for example, the microphone 32 and pushbutton(s) 34, whereas others are indirectly connected using one or more network connections, such as a communications bus 44 or an entertainment bus 46. Examples of suitable network connections include, but are not limited to, a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 may be an OEM-installed (embedded) or aftermarket device that enables wireless voice and/or data communication over wireless carrier system 14 and via wireless networking so that the vehicle 12 may communicate with call center 20, other telematics-enabled vehicles, or some other entity or device. In one example, the telematics unit 30 uses radio transmissions to establish a communications channel (a voice channel and/or a data channel) with wireless carrier system 14 so that voice and/or data transmissions may be sent and received over the channel. By providing both voice and data communication, telematics unit 30 enables the vehicle 12 to offer a number of different services including those related to navigation, telephony, emergency assistance, diagnostics, infotainment, etc. Data may be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the unit 30 may utilize a single call over a voice channel and switch as needed between voice and data transmission over the voice channel, and this may be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem may either be implemented through software that is stored in the telematics unit and is executed by processor 52, or it may be a separate hardware component located internal or external to telematics unit 30. The modem may operate using any number of different standards or protocols such as EVDO, CDMA, GPRS, and EDGE. Wireless networking between the vehicle 12 and other networked devices may also be carried out using telematics unit 30. For this purpose, telematics unit 30 may be configured to communicate wirelessly according to one or more wireless protocols, including, but not limited to, any of the IEEE 802.11 protocols, WiMAX, or Bluetooth. When used for packet-switched data communication such as TCP/IP, the telematics unit 30 may be configured with a static IP address or may set up to automatically receive an assigned IP address from another device on the network such as a router or from a network address server.

Processor 52 may be any type of device capable of processing electronic instructions including microprocessors, microcontrollers, host processors, controllers, vehicle communication processors, and application specific integrated circuits (ASICs). It may be a dedicated processor used only for telematics unit 30 or may be shared with other vehicle systems. Processor 52 executes various types of digitally-stored instructions, such as software or firmware programs stored in memory 54, which enable the telematics unit 30 to provide a wide variety of services. For instance, processor 52 may execute programs or process data to carry out at least a part of the method discussed herein.

Telematics unit 30 may be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit 30 is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle 12, to cite but a few possibilities. In the event that the modules are implemented as VSMs 42 located external to telematics unit 30, they could utilize vehicle bus 44 to exchange data and commands with the telematics unit 30.

GPS module 40 receives radio signals from a constellation 60 of GPS satellites. From these signals, the module 40 may determine vehicle position that is used for providing navigation and other position-related services to the vehicle driver. Navigation information may be presented on the display 38 (or other display within the vehicle 12) or may be presented verbally such as is done when supplying turn-by-turn navigation. The navigation services may be provided using a dedicated in-vehicle navigation module (which may be part of GPS module 40), or some or all navigation services may be done via telematics unit 30, wherein the position information is sent to a remote location for purposes of providing the vehicle 12 with navigation maps, map annotations (points of interest, restaurants, etc.), route calculations, and the like. The position information may be supplied to call center 20 or other remote computer system, such as computer 18, for other purposes, such as fleet management. Also, new or updated map data may be downloaded to the GPS module 40 from the call center 20 via the telematics unit 30.

Apart from the audio system 36 and GPS module 40, the vehicle 12 may include other vehicle system modules (VSMs) 42 in the form of electronic hardware components that are located throughout the vehicle 12 and typically receive input from one or more sensors and use the sensed input to perform diagnostic, monitoring, control, reporting and/or other functions. In one example, each of the VSMs 42 is connected by communications bus 44 to the other VSMs, as well as to the telematics unit 30, and may be programmed to run vehicle system and subsystem diagnostic tests. As examples, one VSM 42 may be an engine control module (ECM) that controls various aspects of engine operation such as fuel ignition and ignition timing, another VSM 42 may be a powertrain control module that regulates operation of one or more components of the vehicle powertrain, and another VSM 42 may be a body control module that governs various electrical components located throughout the vehicle 12, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, haptic devices, and visual display 38. As used herein, the term “vehicle user interface” broadly includes any suitable form of electronic device, including both hardware and software components, which is located on the vehicle 12 and enables a vehicle user to communicate with or through a component of the vehicle 12. Microphone 32 provides audio input to the telematics unit to enable the driver or other occupant to provide voice commands and carry out hands-free calling via the wireless carrier system 14. For this purpose, it may be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons may be used for initiating emergency calls versus regular service assistance calls to the call center 20. Audio system 36 provides audio output to a vehicle occupant and may be a dedicated, stand-alone system or part of the primary vehicle audio system. According to the exemplary embodiment shown here, audio system 36 is operatively coupled to both vehicle bus 44 and entertainment bus 46 and may provide AM, FM and satellite radio, CD, DVD and other multimedia functionality. This functionality may be provided in conjunction with or independent of the infotainment module described above. In one example, visual display 38 is a graphics display, such as a touch screen on the instrument panel or a heads-up display reflected off of the windshield, and may be used to provide a multitude of input and output functions. Various other vehicle user interfaces may also be utilized, as the interfaces of FIG. 1 are only an example of one particular implementation.

In one example, wireless carrier system 14 is a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 may implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication may be used to provide uni-directional or bi-directional communication with the vehicle 12. This may be done using one or more communication satellites 62 and an uplink transmitting station 64. Uni-directional communication may be, for example, satellite radio services, wherein programming content (news, music, etc.) is received by transmitting station 64, packaged for upload, and then sent to the satellite 62, which broadcasts the programming to subscribers. Bi-directional communication may be, for example, satellite telephony services using satellite 62 to relay telephone communications between the vehicle 12 and station 64. If used, this satellite telephony may be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it may communicate directly with a wireless network, such as wireless carrier system 14.

Computer 18 may be one of a number of computers accessible via a private or public network such as the Internet. Each such computer 18 may be used for one or more purposes, such as a web server accessible by the vehicle 12 via telematics unit 30 and wireless carrier 14. Other such accessible computers 18 may be, for example: a service center computer where diagnostic information and other vehicle data may be uploaded from the vehicle 12 via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 may also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are generally coupled to one another via a wired or wireless local area network 90. Switch 80, which may be a private branch exchange (PBX) switch, routes incoming signals so that voice transmissions are usually sent to either the live adviser 86 by regular phone or to the automated voice response system 88 using a voice-over-Internet protocol (VoIP). The live advisor phone may also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 may store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center may instead utilize VRS 88 as an automated advisor or, a combination of VRS 88 and the live advisor 86 may be used.

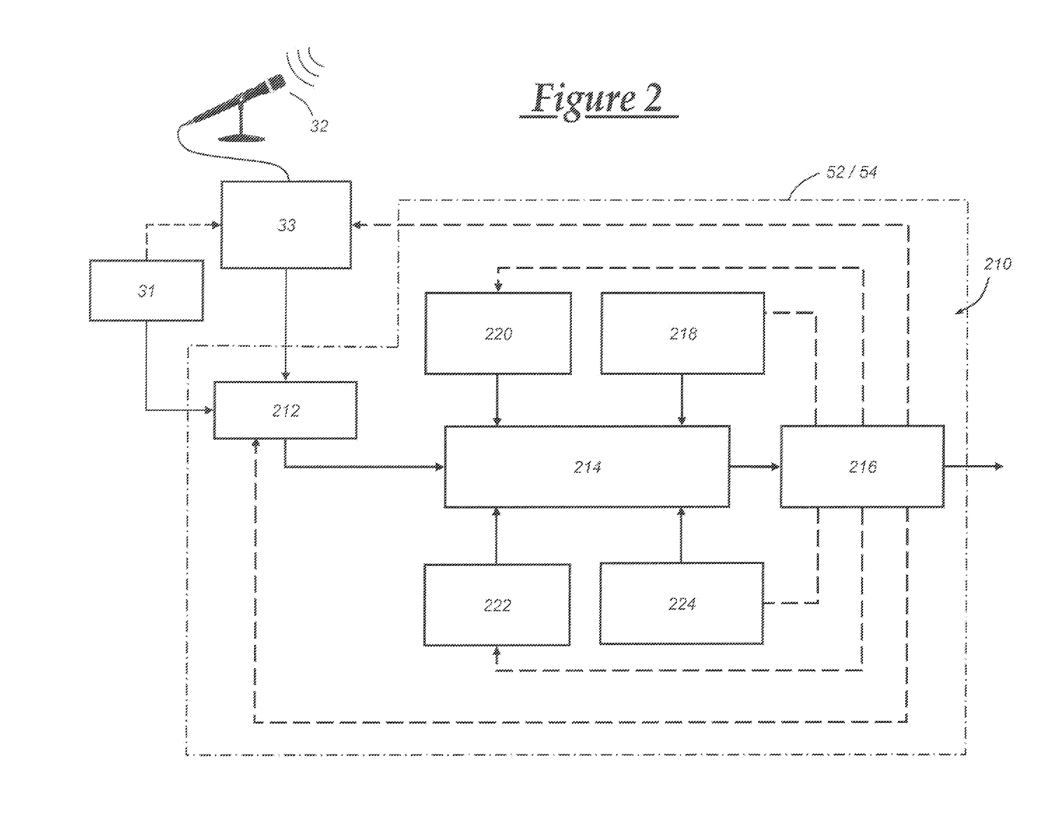

Turning now to FIG. 2, there is shown an exemplary architecture for an automatic speech recognition or ASR system 210 that may be used to enable the presently disclosed method. In general, a vehicle occupant vocally interacts with an ASR system for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like. Generally, ASR extracts acoustic data from human speech, compares and contrasts the acoustic data to stored subword data, selects an appropriate subword which may be concatenated with other selected subwords, and outputs the concatenated subwords or words for post-processing such as dictation or transcription, address book dialing, storing to memory, training ASR models or adaptation parameters, or the like.

ASR systems are generally known to those skilled in the art, and FIG. 2 illustrates just one specific exemplary ASR system 210. The system 210 includes a device to receive speech such as the telematics microphone 32, and an acoustic interface 33 such as a sound card of the telematics unit 30 having an analog to digital converter to digitize the speech into acoustic data. The system 210 also includes a memory such as the telematics memory 54 for storing the acoustic data and storing speech recognition software and databases, and a processor such as the electronic processing device 52 to process the acoustic data. The processor functions with the memory and in conjunction with the following modules: one or more front-end processors or pre-processor software modules 212 for parsing streams of the acoustic data of the speech into parametric representations such as acoustic features; one or more decoder software modules 214 for decoding the acoustic features to yield digital subword or word output data corresponding to the input speech utterances; and one or more post-processor software modules 216 for using the output data from the decoder module(s) 214 for any suitable purpose.

The system 210 may also receive speech from any other suitable audio source(s) 31, which may be directly communicated with the pre-processor software module(s) 212 as shown in solid line or indirectly communicated therewith via the acoustic interface 33. The audio source(s) 31 may include, for example, a telephonic source of audio such as a voice mail system, or other telephonic services of any kind.

One or more modules or models may be used as input to the decoder module(s) 214. First, grammar and/or lexicon model(s) 218 may provide rules governing which words may logically follow other words to form valid sentences. In a broad sense, a grammar may define a universe of vocabulary the system 210 expects at any given time in any given ASR mode. For example, if the system 210 is in a training mode for training commands, then the grammar model(s) 218 may include all commands known to and used by the system 210. In another example, if the system 210 is in a main menu mode, then the active grammar model(s) 218 may include all main menu commands expected by the system 210 such as call, dial, exit, delete, directory, or the like. Second, acoustic model(s) 220 assist with selection of most likely subwords or words corresponding to input from the pre-processor module(s) 212. Third, word model(s) 222 and sentence/language model(s) 224 provide rules, syntax, and/or semantics in placing the selected subwords or words into word or sentence context. Also, the sentence/language model(s) 224 may define a universe of sentences the system 210 expects at any given time in any given ASR mode, and/or may provide rules, etc., governing which sentences may logically follow other sentences to form valid extended speech. In each of these examples, the relevant model may be trained to learn the voices produced by one or more automated telephone attendants (ATAs). For instance, the identity of the voices used by ATAs may not vary greatly nor would the number of commands. As a result, the grammar or lexicon models 218 may be quickly and easily prepared to identify one of a limited number of known and identified voices used by ATAs and also the likely words and/or commands that ATAs frequently use. As an example, an ATA could ask a caller “please enter your conference call access code.” The ASR system 210 may be trained to look for each of these words/phrases and/or the voice likely to speak them.

According to an alternative exemplary embodiment, some or all of the ASR system 210 may be resident on, and processed using, computing equipment in a location remote from the vehicle 12 such as the call center 20. For example, grammar models, acoustic models, and the like may be stored in memory of one of the servers 82 and/or databases 84 in the call center 20 and communicated to the vehicle telematics unit 30 for in-vehicle speech processing. Similarly, speech recognition software may be processed using processors of one of the servers 82 in the call center 20. In other words, the ASR system 210 may be resident in the telematics unit 30 or distributed across the call center 20 and the vehicle 12 in any desired manner.

First, acoustic data is extracted from human speech wherein a vehicle occupant speaks into the microphone 32, which converts the utterances into electrical signals and communicates such signals to the acoustic interface 33. A sound-responsive element in the microphone 32 captures the occupant's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the telematics memory 54 and then processed by the telematics processor 52 or may be processed as they are initially received by the processor 52 in real-time.

Second, the pre-processor module(s) 212 transforms the continuous stream of digital speech data into discrete sequences of acoustic parameters. More specifically, the processor 52 executes the pre-processor module(s) 212 to segment the digital speech data into overlapping phonetic or acoustic frames of, for example, 10-30 millisecond (ms) duration. The frames correspond to acoustic subwords such as syllables, demi-syllables, phones, diphones, phonemes, or the like. The pre-processor module(s) 212 also performs phonetic analysis to extract acoustic parameters from the occupant's speech such as time-varying feature vectors, from within each frame. Utterances within the occupant's speech may be represented as sequences of these feature vectors. For example, and as known to those skilled in the art, feature vectors may be extracted and may include, for example, vocal pitch, energy profiles, spectral attributes, and/or cepstral coefficients that may be obtained by performing Fourier transforms of the frames and decorrelating acoustic spectra using cosine transforms and cepstrum. Acoustic frames and corresponding parameters covering a particular duration of speech are concatenated into unknown test pattern of speech to be decoded.

Third, the processor executes the decoder module(s) 214 to process the incoming feature vectors of each test pattern. The decoder module(s) 214 is also known as a recognition engine or classifier, and uses stored known reference patterns of speech. Like the test patterns, the reference patterns are defined as a concatenation of related acoustic frames and corresponding parameters. The decoder module(s) 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques may include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian HMM process identifies a best hypothesis corresponding to the most probable utterance or subword sequence for a given observation sequence of acoustic feature vectors, and its confidence values may depend on a variety of factors including acoustic signal-to-noise ratios associated with incoming acoustic data. The HMM may also include a statistical distribution called a mixture of diagonal Gaussians, which yields a likelihood score for each observed feature vector of each subword, which scores may be used to reorder the N-best list of hypotheses. The HMM engine may also identify and select a subword whose model likelihood score is highest.

In a similar manner, individual HMMs for a sequence of subwords may be concatenated to establish single or multiple word HMM. Thereafter, an N-best list of single or multiple word reference patterns and associated parameter values may be generated and further evaluated.

In one example, the speech recognition decoder 214 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern may include a series of feature vectors representative of one or more words or subwords and may be based on particular speakers, speaking styles, and audible environmental conditions. Those skilled in the art will recognize that reference patterns may be generated by suitable reference pattern training of the ASR system 210 and stored in memory. Those skilled in the art will also recognize that stored reference patterns may be manipulated, wherein parameter values of the reference patterns are adapted based on differences in speech input signals between reference pattern training and actual use of the ASR system 210. For example, a set of reference patterns trained for one vehicle occupant or certain acoustic conditions may be adapted and saved as another set of reference patterns for a different vehicle occupant or different acoustic conditions, based on a limited amount of training data from the different vehicle occupant or the different acoustic conditions. In other words, the reference patterns are not necessarily fixed and may be adjusted during speech recognition.

Using the in-vocabulary grammar and any suitable decoder algorithm(s) and acoustic model(s), the processor accesses from memory several reference patterns interpretive of the test pattern. For example, the processor may generate, and store to memory, a list of N-best vocabulary results or reference patterns, along with corresponding parameter values. Exemplary parameter values may include confidence scores of each reference pattern in the N-best list of vocabulary and associated segment durations, likelihood scores, signal-to-noise ratio (SNR) values, and/or the like. The N-best list of vocabulary may be ordered by descending magnitude of the parameter value(s). For example, the vocabulary reference pattern with the highest confidence score is the first best reference pattern, and so on. Once a string of recognized subwords are established, they may be used to construct words with input from the word models 222 and to construct sentences with the input from the language models 224.

Finally, the post-processor software module(s) 216 receives the output data from the decoder module(s) 214 for any suitable purpose. In one example, the post-processor software module(s) 216 may identify or select one of the reference patterns from the N-best list of single or multiple word reference patterns as recognized speech. In another example, the post-processor module(s) 216 may be used to convert acoustic data into text or digits for use with other aspects of the ASR system 210 or other vehicle systems. In a further example, the post-processor module(s) 216 may be used to provide training feedback to the decoder 214 or pre-processor 212. More specifically, the post-processor 216 may be used to train acoustic models for the decoder module(s) 214, or to train adaptation parameters for the pre-processor module(s) 212.

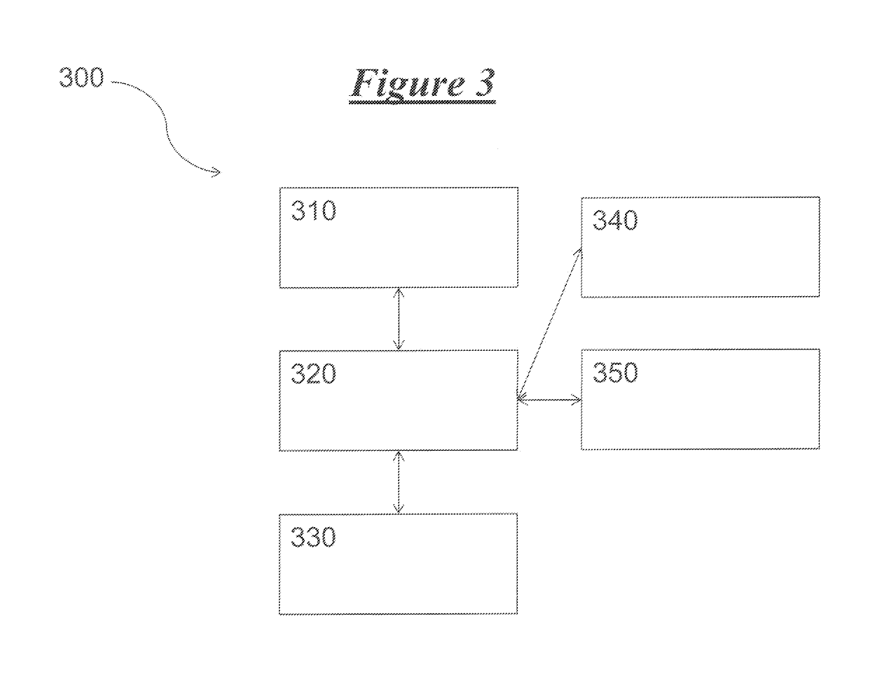

Turning now to FIG. 3, there is shown an exemplary architecture for a password management system 300 that may be used to enable the presently disclosed method. Like the ASR system 210, some or all of the password management system 300 may be resident on, and proceed using, vehicle electronics 28 such as telematics unit 30; alternatively, some or all of the password management system 300 may be resident on, and processed using, computing equipment in a location remote from the vehicle 12 such as the call center 20. As such, the various modules of password management system 300, as will be described in greater detail below, are designed to work in cooperation with the systems and modules of communications system 10 and ASR system 210.

Password management system 300 includes speaker identification module 310, interaction manager 320, speech detection module 330, scheduler module 340, and password database 350. Speaker identification module 310 may be implemented in connection with ASR system 210, and, as used herein the term “speaker identification” refers to the ASR system 210 finding the identity of “who” is speaking, rather than what they are saying. In the speaker identification module 310, recognizing the speaker can simplify the task of translating speech in systems that have been trained on specific person's voices or it can be used to authenticate or verify the identity of a speaker as part of a security process. There are two major applications of speaker recognition technologies and methodologies. If the speaker claims to be of a certain identity and the voice is used to verify this claim, this is called verification or authentication. On the other hand, identification is the task of determining an unknown speaker's identity. In a sense speaker verification is a 1:1 match where one speaker's voice is matched to one template (also called a “voice footprint” or “voice model”) whereas speaker identification is a 1:N match where the voice is compared against N templates. Each speaker recognition system has two phases: Enrollment and verification. During enrollment, the speaker's voice is recorded and typically a number of features are extracted to form a voice footprint, template, or model. In the verification phase, a speech sample or “utterance” is compared against a previously created voice footprint. For identification systems, the utterance is compared against multiple voice footprints in order to determine the best match(es) while verification systems compare an utterance against a single voice footprint. Because of the process involved, verification is faster than identification. It is further noted that the speaker recognition system may be used to prevent unauthorized access to a user's personal information, by ensuring that only a particular speaker can access such speaker's personal information through the telematics unit 30.

In some further embodiments, the user is able to define a level of speaker identification. For example, the various speakers may have associated therewith different levels of identification, based on the user's configuration of system 300. This functionality allows the system 300 to apply different levels of speaker identification, depending on the particular speaker, i.e., depending of the particular user of the system 300.

Interaction manager 320 is further provided in connection with ASR system 210 and communications system 10. An “interaction” as used herein is defined as a complete exchange between a user and the password system 300. The interaction manager 320 manages interactions between multiple speech applications and a user so that (a) it is clear to the user which application the user is speaking to, and (b) it is clear to the applications which application is active. As used herein, the term “application” can refer to any electronic application that is accessible through telematics unit 30 and requires as password or other passcode for access thereto, including, but not limited to, voicemail, e-mail, telephone conferencing services, Microsoft Outlook® calendaring services, banking services, concierge services, and other applications as will be envisioned by those having ordinary skill in the art. When an application wishes to utilize the ASR system 210, the application submits an interaction to the interaction manager 320. The submitted interaction is placed at the end of an interaction list containing interactions to be processed by the ASR system 210. In one implementation, this indication is made by the application designating a particular grammar to be used with the interaction that is configured to be processed immediately. The interaction manager 320 keeps applications informed as to the status of interactions belonging to the applications. For example, the interaction manager 320 sends messages to applications, such as an interaction activated message. The interaction manager 320 keeps track of the interactions being processed by the ASR system 210 so that the ASR system 210 only processes one interaction at a time. In this way, the interactions are processed in an orderly manner that allows multiple applications to run concurrently on the ASR system 210, even if the multiple applications each use a different grammar. As a result, a vehicle occupant can better communicate with each of the applications.

Speech detection module 330 is further provided in connection with ASR system 210 and communications system 10. As noted initially above, speech detection module 330 may be implemented as an ASR system for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control; listening to the audio received from a service and detect a set of known sentences from the service (for example “please enter you pin number” or “please enter your conference number”); or the like. Generally, speech detection module 330 extracts acoustic data from human or service speech, compares and contrasts the acoustic data to stored subword data, selects an appropriate subword which may be concatenated with other selected subwords, and outputs the concatenated subwords or words for post-processing such as dictation or transcription, address book dialing, storing to memory, training ASR models or adaptation parameters, or the like.

Scheduler module 340 is further provided in connection with ASR system 210 and communications system 10. Scheduler module 340 is provided for scheduling communications events, displaying reminders to the user of such events, and facilitating initiation of the communications event. Communications events include events where communications system 10 communicates with one or more third party communications device, including events such as, for example, audio phone calls, video phone calls and electronic messaging including email and instant text messaging and other audio and visual messages. Scheduler module 340 may be implemented as part of a general event scheduling application, such as calendar 301 for example. The use of calendar applications on PDA-type devices and personal computers to schedule and provide reminders of general events, such as appointments, meetings, birthdays and the like is common place. In this manner, the password management system 300 has the capability to predefine times wherein the user desires to initiate an interaction with a particular application. For example, the predefined times may include particular dates and times. In this case, therefore, the system 300 will set the context of the interaction with the user by preselecting the application based on the predefined schedule, in communication with the scheduler module 340.

Password database 350 is further provided in connection with ASR system 210 and communications system 10. As noted above, passwords or passcodes are typically required to access one or more of the application accessible through the telematics unit 30. Using the speech detection module, as will be described in greater detail below, the user may speak a password or passcode for access to a particular application in the telematics unit 30 or the user can access the password database using any other interaction modality such as tactile devices. The user can also access it remotely using mobile devices, PDAs and computers. In this manner, the user can input or store passwords for various apps in the database. As used herein, the term “remotely” refers to direct commutation with the device or using a network. The password or passcode is learned by the system 210 in advance of the user requesting access to the particular application. The password database 350 is thus employed to store the passwords for accessing the various applications, such as voicemail, email, calendar, bank accounts, etc. The password database 350 may be employed in connection with the speaker identification module 310, such that the only the particular user's voice speaking the password will gain access into a particular application.

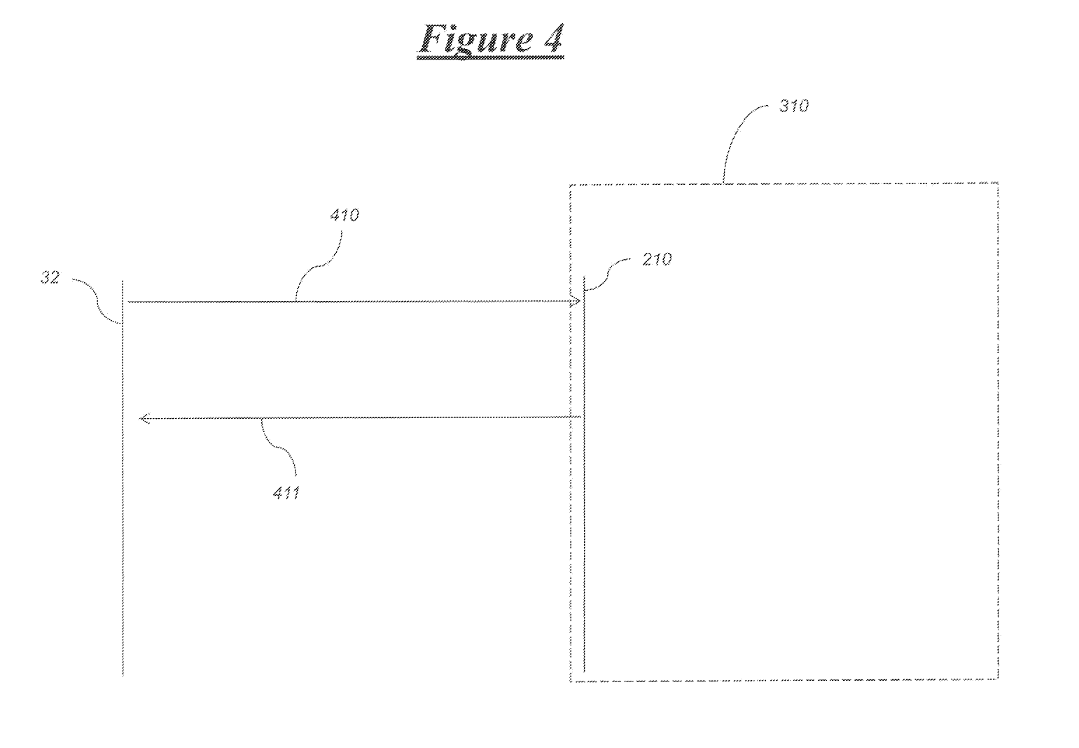

Turning now to FIGS. 4-7, there are various methods of operating a vehicle telematics unit 30. As can be appreciated in light of the disclosure, the order of operation within the method is not limited to the sequential execution as illustrated in FIGS. 4-7, but may be performed in one or more varying orders as applicable and in accordance with the present disclosure. In various embodiments, the method of FIGS. 4-7 can be scheduled to run based on predetermined events, and/or can run continually during operation of the vehicle 12. The method shown in FIG. 4 begins by optimizing a speech recognition function at the vehicle 12 to recognize a group of voices used with one or more automated telephone attendants (ATAs). ATAs, which also can be referred to as interactive voice response (IVR) systems, generally transfer callers to their desired number without the use of human receptionists. That is, callers can interact with computers used by the ATAs via voice output and/or dual-tone multi-frequency (DTMF) tones or commands. At least a portion of this can be accomplished by using the ASR system 210 described above. The ASR system 210 can not only receive speech from a vehicle occupant, but can also be directed to receive speech generated by an ATA. In that way, the ASR system 210 can be alternately directed to listening to either the telematics service subscriber/vehicle occupant or the ATA, depending on which source is speaking The term “caller” as used herein can also be read to include “vehicle occupant” or “telematics service user.”

Moreover, of the ATAs in use, only a limited number of different voices may be used to generate output from the ATA. Or in other words, there may be only a handful of unique voices that are recorded for use with an ATA. And the number of requests that can be issued by the ATA may be limited as well. For example, the ATA can be expected to recite commands such as “please say the conference call access code” or “please say the passcode.” These commands can be reasonably predicted based on the context of the conversation used to set up a conference call. Given the limited number of different voices and/or the limited phrases or commands that the ATA can generate, the ASR system 210 can be programmed (e.g. specifically trained) to anticipate these voices and/or commands as is discussed above.

As shown in FIG. 4, the vehicle occupant “trains” the ASR system 210 to the particular user's voice, as part of the speaker identification module 310. Arrow 410 indicates the user sending audio (an “utterance”) via microphone 32 to the speaker recognition module 310 in order to generate an audio signature. In some embodiments, subsequently, the speaker identification module 310 may send a return signal, via the audio system 36 of the vehicle 12, to indicate in the form of a “prompt” back to the user that the audio signature was generated for that user, as shown by arrow 411. In this manner, the module 310 is able to learn the voice signature of a particular user for later use when that user desires to access a particular application via telematics unit 30.

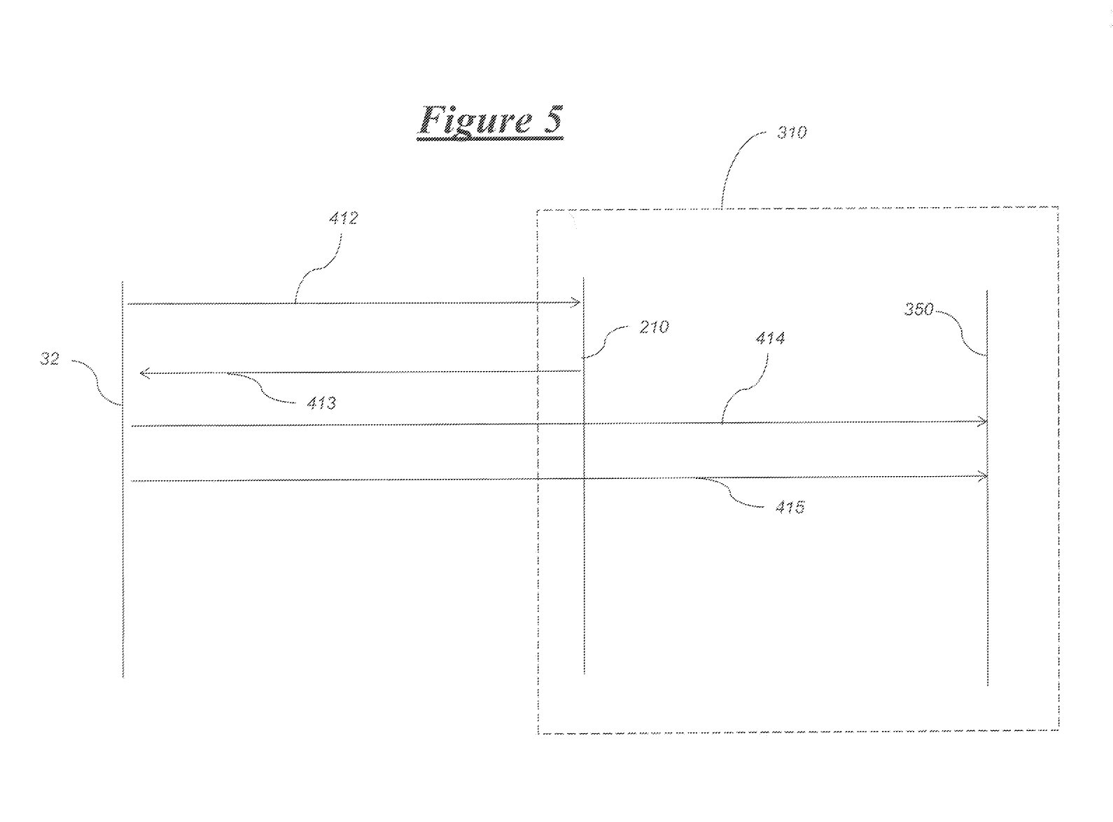

As shown in FIG. 5, the user may further train the password management system 300 by supplying passwords for the various applications that the user may seek to access. At 412, the user sends audio to the speaker recognition system 310 in order to be identified. The particular audio that is sent may be any suitable verbal command or utterance, as will be appreciated by those having ordinary skill in the art. If desired, in order to indicate that the user was identified, the module 310 may send a return prompt via the audio system 36, at 413, indicating that the user was identified. In one embodiment, the user may then verbally communicate to ASR system 210 a password for a particular application. For example, the user may verbally indicate an application for which a password is required, and the ASR system 210 may then respond with a request to verbally indicate the password for such application, at which point, the password will be stored into password database 350 using system 300, for example using. In an alternative embodiment, as indicated at 414, an external password system may be used to communicate the passwords for various applications to the password database 350, for example via communications system 10, such that the user is not required to verbally enter passwords for each and every application desired.

Furthermore, upon activation of the system 300, the user may create their online profile, with access to their Outlook® calendar. The online profile may include important information stored under separate contexts, such as voicemail, teleconference system PIN, bank account PIN. These contexts may be compiled into binary/encrypted format after online creation, as is known in the art. In this manner, passwords and passcodes may be saved into the system 300 for any of a number of applications that the user may desire to access while driving, such as voicemail, email, Outlook® calendar, teleconferencing services, and bank accounts, among other as may be envisioned by those having ordinary skill in the art.

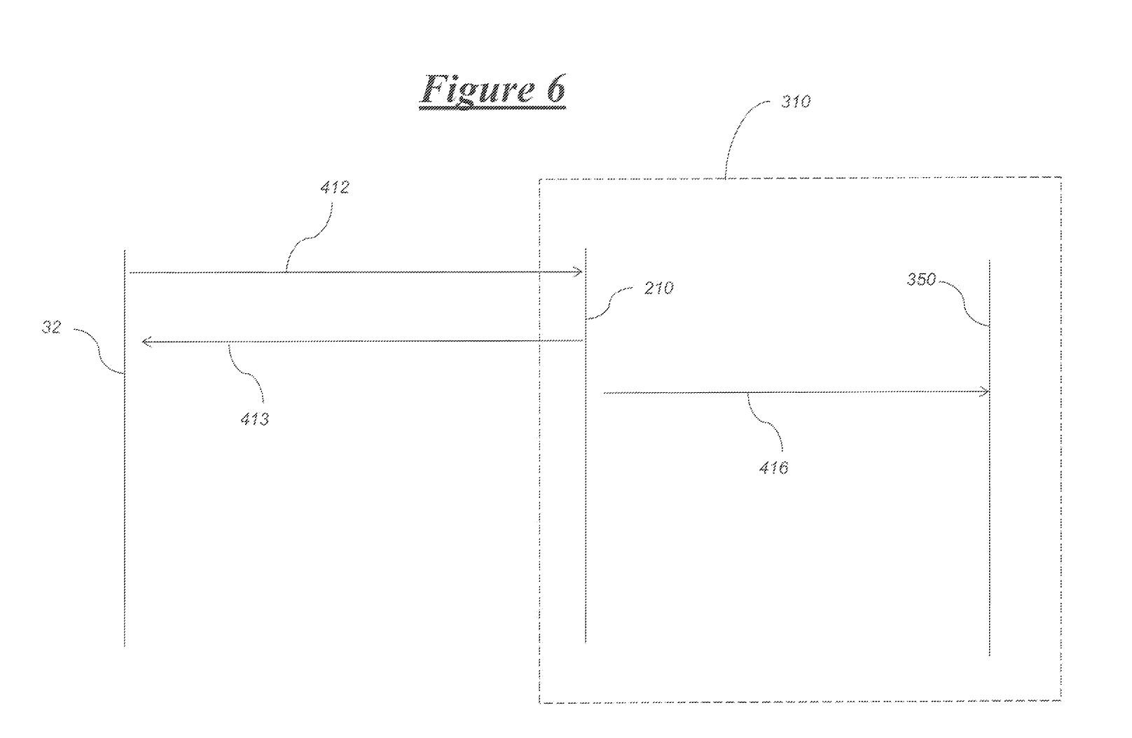

As shown in FIG. 6, the system 300 may become initially activated upon the user entering the vehicle 12, or at any other suitable time. At 412, the user sends audio to the speaker recognition system 310 in order to be identified. The particular audio that is sent may be any suitable verbal command or utterance, as will be appreciated by those having ordinary skill in the art. If desired, in order to indicate that the user was identified, the module 310 may send a return prompt via the audio system, at 413, indicating that the user was identified. At this point, as indicated by arrow 416, the system 300 is in an “active listening mode,” wherein the system 300 is continuously monitoring audio signals received through microphone 32 for any command directed at the system 300. In this manner, once the user initially enters the vehicle 12 and before driving, the system 300 is initiated and ready for any commands that the user may input and any subsequent point during the user's drive.

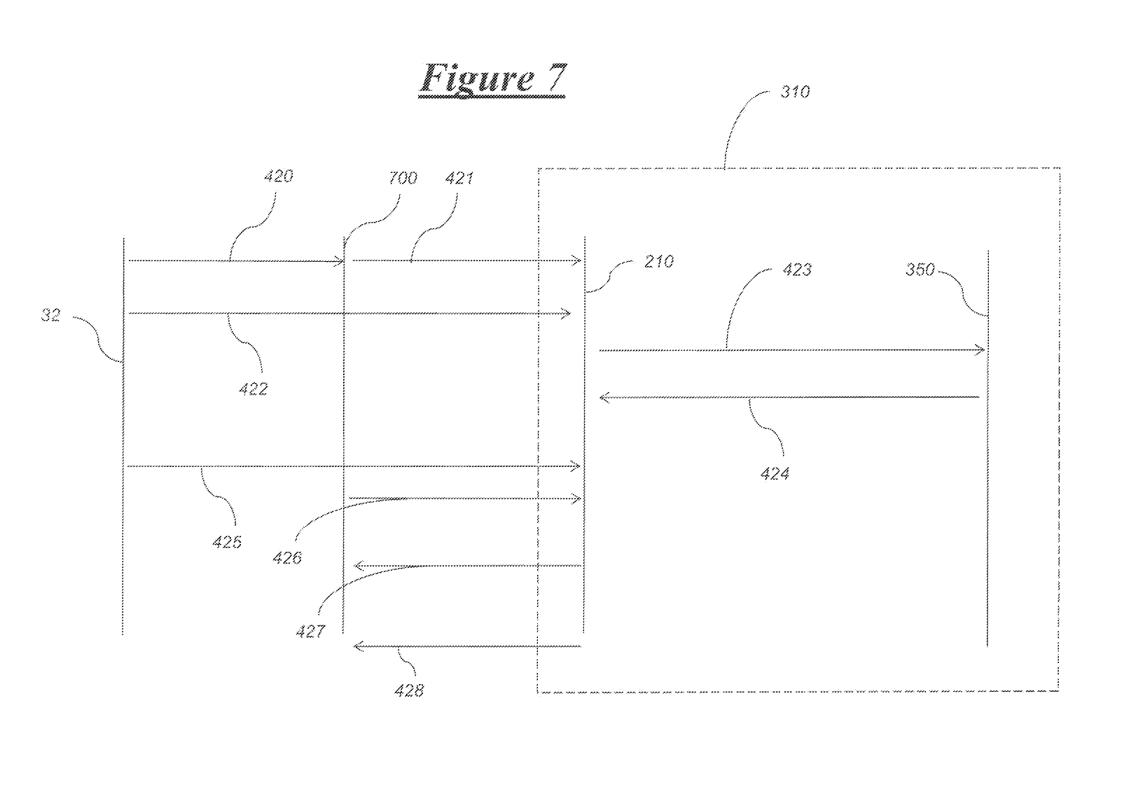

As shown in FIG. 7, a method is illustrated for the operation of password management system 300, in connection with ASR system 210, while the user is operating vehicle 12. At 420, the user initiates a call or other interaction using the telematics unit 30. The call is directed toward one or more of the aforementioned applications 700, such as voicemail, email, teleconferencing services, electronic calendar, bank account, etc. For purposes of illustrating the method shown in FIG. 7, the bank account application 700 will be used. At 421, electronic communication between the application 700, i.e., the bank telephone system and the password management system is initiated. As shown by arrow 422, the password management system 300 is automatically informed about the user's selected application 700 by virtue of the number dialed via the telematics system 30. Alternatively, the user may provide the context by speaking such context verbally, such audio signal being received into system 300 by the microphone 32 and recognized by speech recognition unit 330. At 423, internally within password management system 300, the speech recognition module and/or interaction manager 320 requests information regarding the relevant password (for the particular application 700 requested) from the password database 350. At 424, the password is provided from the password database 350. Thereafter, at 425, the system 300 may detect a request from the user to provide the password to the application 700 with which the user is in communication, such as the bank. In response, at 427, the system 300 provides DTMF into the call response to the user's request. In an alternative embodiment, as shown at 426, the password management system 300 detects a prompt (for example voice prompt or tone prompt) from the application 700, such as the bank, requesting, for example, a passcode. In response, at 428, the system 300 provides DTMF into the call response to the application's 700 request.

In this manner, the user is able to initiate a call to a particular application and, once the call is placed to the application, the password management system 300 is able to provide the application with the required password for the user to access the application, using, for example, DTMF. Voice recognition allows the system to identify the user, and prior training and password programming allows the system 300 to store passwords for the user's access of a variety of application, such as voicemail, email, teleconferencing services, electronic calendar, bank account, etc. Desirably, the user is able to securely access such applications without needing to manually input the passcode while driving, thus saving the user time, and enhancing the user's safety and driving experience. For the sake of confidentiality the password database can be stored in an encrypted format such as compiled binary data to ensure optimal cyber security especially when the user password profile is stored on remote back-office servers or even on the embedded platform.

While exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes may be made in the function and arrangement of elements without departing from the scope of the disclosure as set forth in the appended claims and the legal equivalents thereof.

What is claimed is:

1. A method, comprising:
storing an application access code provided from a user of a telematics service;
initiating a call using the telematics service and utilizing a user speech input signature to access user data during the call to verify the user;
receiving a request for the access code from the application during the call;
determining that the application has requested the access code using a speech recognition function associated with the vehicle; and
sending the stored application access code to the application based on the determination of the speech recognition function.

2. The method of claim 1, wherein storing the application access code comprises storing an application access code for a voicemail application.

3. The method of claim 1, wherein storing the application access code comprises storing an application access code for an electronic calendaring application.

4. The method of claim 1, wherein storing the application access code comprises storing an application access code for a banking application.

5. The method of claim 1, wherein sending the stored access code to the application comprises sending the stored access code in DTMF format.

6. The method of claim 1, further comprising initiating a call from the vehicle to the application, wherein initiating the call from a vehicle to the application is based on verbal commands received from a vehicle occupant.

7. The method of claim 6, wherein initiating the call from a vehicle to the application is based on a predefined schedule.

8. A system, comprising:
an access code database configured to store an application access code provided from a telematics service user;
a telematics unit configured to initiate a call from a vehicle to an application;
an interaction manager configured to receive a request for the access code from the application during the call;
a speech recognition module configured to determine that the application has requested the access code; and
an electronic communication system configured to send the stored access code to the application based on the determination of the speech recognition function.

9. The system of claim 8, wherein the application access code comprises an access code for a voicemail application.

10. The system of claim 8, wherein the application access code comprises an access code for an electronic calendaring application.

11. The system of claim 8, wherein the application access code comprises an access code for a banking application.

12. The system of claim 8, wherein the stored access code is sent in DTMF format.

13. The system of claim 8, wherein initiating the call from a vehicle to the application is based on verbal commands received from a vehicle occupant.

14. The system of claim 8, wherein initiating the call from a vehicle to the application is based on a predefined schedule.

15. A vehicle, comprising:
a telematics unit in operable electronic communication with a password management system, the password management system comprising:
an access code database configured to store an application access code provided from a telematics service user, the telematics unit being configured to initiate a call from a vehicle to an application;
an interaction manager configured to receiving a request for the access code from the application during the call;
a speech recognition module configured to determine that the application has requested the access code; and
an electronic communication system configured to send the stored access code to the application based on the determination of the speech recognition function.

16. The vehicle of claim 15, wherein the application access code comprises an access code for a voicemail application or an electronic calendaring application.

17. The vehicle of claim 15, wherein the telematics unit identifies a speaker to prevent unauthorized access to confidential information.

18. The vehicle of claim 15, wherein the application access code comprises an access code for a banking application.

19. The vehicle of claim 15, wherein the stored access code is sent in DTMF format.

20. The vehicle of claim 15, wherein initiating the call from a vehicle to the application is based on verbal commands received from a vehicle occupant or is based on a predefined schedule.
